(19) United States
(12) Patent Application Publication
(10) Pub. No.: US 2007/0179208 A1
(43) Pub. Date: Aug. 2, 2007

(54) Low-density polyurethane foam materials and their use in shoe soles

(75) Inventors: Markus Schütte, Osnabrück (DE); Anton Kappes, Olching (DE); Marco Ortalda, Torino (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/597,790

(22) PCT Filed: May 21, 2005
(86) PCT No.: PCT/EP05/05519

§ 371 Date: Nov. 28, 2006

(30) Foreign Application Priority Data
May 31, 2004 (IT) MI 2004 A 001096

(51) Int. Cl. C08J 9/00

(52) U.S. Cl. 521/99

(57) ABSTRACT

The invention relates to “low-density” polyurethane foams, preferably “low-density” flexible integral polyurethane foams, i.e. polyurethane foams with density of from 120 grams per liter (herein after termed g/L) to less than 300 g/L, obtainable via reaction of polyisocyanates (a) with a polyol component (b) comprising the following constituents: polyesterol (b-1) and polymer polyesterol (b-2), where the proportion of polymer polyesterols (b-2) is from more than 5 to less than 50% by weight, based on the total weight of component (b), and, if appropriate, chain extenders (c), in the presence of water (d) as blowing agent, and also to their use in shoe soles.

The invention relates to “low-density” polyurethane foams, preferably “low-density” flexible integral polyurethane foams, i.e. polyurethane foams with density of from 120 grams per liter (hereinafter termed g/L) to less than 300 g/L, obtainable via reaction of polyisocyanates (a) with a polyol component (b) comprising the following constituents: polyesterol (b-1) and polymer polyesterol (b-2), where the proportion of polymer polyesterols (b-2) is from more than 5 to less than 50% by weight, based on the total weight of component (b), and, if appropriate, chain extenders (c), in the presence of water (d) as blowing agent, and also to their use in shoe soles.

Production of shoe soles from microcellular PU elastomers with molding densities above 400 g/L is known from the prior art and is described by way of example in EP-A463479. Shoe soles and other vibration-absorbent elements for the shoe sector with lower densities can in principle be obtained by increasing the proportion of physical and/or chemical blowing agent. In recent years, legislation (the Montreal protocol) has led to preference for solely water-blown systems over conventional systems obtained using physical blowing agents.

By way of example, DE-A-2402734 describes PU systems for production of shoe soles in which isocyanate prepolymers based on polyesterols are reacted with polyol components based on polyetherols. The lowest molding density listed in the examples is 400 g/L. EP-A-0358328 follows a similar approach, the isocyanate prepolymers used being reaction products of MDI and mixtures of polyesterols and polyetherols.

EP-A-12119654 describes low-density PU shoe soles using specific polyesterols prepared via reaction of aromatic dicarboxylic acids, such as terephthalic acid, with glycols.

EP-A-1225199 moreover discloses preparation of low-density polyurethane shoe soles where, however, carbon dioxide is necessarily used as blowing agent.

WO 97/32923 discloses production of low-density polyurethane shoe soles, a substantial feature being compliance with a specific ratio of cell diameter of the core to cell diameter of the skin.

EP-A-358328 describes low-density polyurethane shoe soles based on hybrid prepolymers composed of polyesterols and polyetherols.

However, reducing the density of the shoe soles leads to an undesired fall-off in service properties and in processing properties. The fall-off in these properties is additionally amplified by the increased content of water. For this reason, shoe soles composed of polyurethane (PU) with densities<300 g/L, for example for sports shoes, have hitherto been unable to compete successfully with materials such as polylethylene-co-vinyl acetate) (EVA).

It was therefore an object of the invention to provide a polyurethane foam which can be used in the form of polyurethane shoe soles in the density range from 120 to less than 300 g/L, where the inventive foam is intended to have the fewest possible, and preferably no, defects both in the core and on the surface. The nature of the reaction mixture underlying the foam is moreover to be such as to permit production of shoes of relatively complicated shape substantially without surface defects and with minimum demolding time. Demolding time is the minimum time for which the molding has to remain in the closed mold to avoid mechanical damage to the foam during demolding.

Unexpectedly, the object underlying this invention could be achieved via the use of a specific polyol component composed of polyesterols and of polymer polyesterols, and also preferably of a specific isocyanate component.

The invention therefore provides a polyurethane foam with density of from 120 g/L to less than 300 g/L,

obtainable via reaction of

a) a polyisocyanate component with

b) a polyol component, comprising the following constituents:

b-1) polyesterols, and

b-2) polymer polyesterols, where the proportion of polymer polyesterols (b-2) is from more than 5 to less than 50% by weight based on the total weight of component (b), and

c) if appropriate, chain extenders, in the presence of

d) blowing agent comprising water.

The inventive polyurethane foams are preferably integral foams, in particular foams to DIN 7726. In one preferred embodiment, the invention provides integral foams based on polyurethanes with Shore hardness in the range from 20-90 A, preferably from 25 to 60 Shore A, in particular from 30 to 55 Shore A, measured to DIN 53505. The inventive integral foams moreover preferably have tensile strengths of from 0.5 to 10 N/mm², preferably from 1 to 5 N/mm², measured to DIN 53504. The inventive integral foams moreover preferably have elongation of from 100 to 800%, preferably of from 200 to 500%, measured to DIN 53504. The inventive integral foams moreover preferably have rebound resilience of from 20 to 60% to DIN 53 512. Finally, the inventive integral foams preferably have tear propagation resistance of from 1 to 10 N/mm, preferably from 1.5 to 5 N/mm, measured to ASTM D3574.

In particular, the inventive polyurethane foams are elastomeric flexible integral polyurethane foams.

The inventive polyurethane foams have density of from 120 g/L to less than 300 g/L. They preferably have density of from 150 g/L to 295 g/L, more preferably from 180 g/L to 290 g/L, still more preferably from 190 g/L to 288 g/L, particularly preferably from 210 g/L to 285 g/L, in particular from 220 g/L to 280 g/L. The density of the polyurethane foam here means the average density over the entire foam, i.e. in the case of integral foams this information relates to the average density of the entire foam inclusive of core and outer layer.

The polyisocyanate component (a) used for production of the inventive polyurethane foams comprises the aliphatic, cycloaliphatic, and aromatic bi- or polyfunctional isocyanate (constituent a-1) known from the prior art, and also any desired mixture of these. Examples are diphenylmethane 4,4′-diisocyanate, mixtures composed of monomeric diphenylmethane diisocyanates and of diphenylmethane diisocyanate homologs having an increased number of rings (polymer MDI), tetramethylene diisocyanate, hexamethylene diisocyanate (HDI), tolylene diisocyanate (TDI), and mixtures of these.

It is preferable to use 4,4′-MDI and/or HDI. The 4,4′-MDI used with particular preference may comprise very small amounts, up to about 10% by weight, of allophanate-modified or uretoneimine-modified polyisocyanates. Use may also be made of very small amounts of polyphenylene polymethylene polyisocyanate (crude MDI). The total amount of these high-functionality polyisocyanates should not exceed 5% by weight of the isocyanate used.

The polyisocyanate components (a) are preferably used in the form of polyisocyanate prepolymers. These polyisocyanate prepolymers are obtainable by reacting polyisocyanates (a-1) with polyols (a-2) described above, for example at temperatures of from 30 to 100° C., preferably at about 80° C., to give the prepolymer. The polyol:polyisocyanate ratio here is selected in such a way that the NCO content of the prepolymer is from 8 to 28% by weight, preferably from 14 to 26% by weight, particularly preferably from 17 to 23% by weight. In order to exclude side reactions due to atmospheric oxygen, the reaction may be carried out under inert gas, preferably nitrogen.

If appropriate, chain extenders (a-3) may also be added to the reaction to give the polyisocyanate prepolymer. Suitable chain extenders for the prepolymer (a-3) are dihydric or trihydric alcohols, preferably branched dihydric or trihydric alcohols with molar mass less than 450 g/mol, particularly preferably less than 400 g/mol, in particular less than 300 g/mol. It is preferable to use dipropylene glycol and/or tripropylene glycol. Adducts of dipropylene glycol and/or tripropylene glycol with alkylene oxides, preferably propylene oxide, are also suitable.

Polyols (a-2) are known to the person skilled in the art and are described by way of example in “Kunststoffhandbuch [Plastics handbook], 7, Polyurethane [Polyurethanes]”, Carl Hansel Verlag, 3^{rd} edition 1993, chapter 3.1.

The polyols (a-2) used comprise polyesterols. The polyesterols used preferably have an OH number of from 20 to 100, preferably from 30 to 60. They also generally have a theoretical functionality of from 1.9 to 4, preferably from greater than 2 to 3.

Polyesterols explained in the description of component (b-1) are preferably used as component (a-2). It is also preferable that component (a-2) comprises less than 10% by weight of polyetherols, based on the total weight of component (a-2). In particular, component (a-2) comprises no polyetherols and is particularly preferably composed solely of polyesterols.

In one particularly preferred embodiment, branched polyesterols are used as components (a-2). The branched polyesterols preferably have functionality of from more than 2 to 3, in particular from 2.2 to 2.8. The branched polyesterols moreover preferably have a number-average molar mass of from 500 to 5000 g/mol, particularly preferably from 2000 to 3000 g/mol. In relation to the starting materials (acids and alcohols) used for preparation of the branched polyester (a-2), reference is made to the statements below concerning component (b-2).

The polyol component (b) comprises polyesterols (b-1) and polymer polyesterols (b-2).

The polyesterols (b-1) used are generally prepared via condensation of polyhydric alcohols, preferably of diols, having from 2 to 12 carbon atoms, preferably from 2 to 6 carbon atoms, with polybasic carboxylic acids having from 2 to 12 carbon atoms, e.g. succinic acid, glutaric acid, adipic acid, phthalic acid, isophthalic acid, and/or terephthalic acid, or a mixture of these. Examples of suitable di- and polyhydric alcohols are ethanediol, diethylene glycol, 1,4-butanediol, 1,5-pentanediol, and/or 1,6-hexanediol, and mixtures of these.

The polyesterols used generally have average theoretical functionality of from 2 to 4, preferably from more than 2 to less than 3. The polyesterols used moreover generally have an average OH number of from 20 to 200, preferably from 30 to 90.

In one preferred embodiment, the polyesterols (b-1) used have viscosity of from 150 mPas to 600 mpas, preferably from 200 mPas to 550 mPas, more preferably from 220 mPas to 500 mPas, particularly preferably from 250 mPas to 450 mPas, and in particular from 270 mPas to 350 mPas, measured to DIN 53 015 at 75° C.

The second constituent of polyol components (b) is a polymer polyesterol (b-2). This is what is known as a polymer polyol, whose usual content of, preferably thermoplastic, polymers is from 5 to 50% by weight, preferably from 10 to 45% by weight, particularly preferably from 25 to 40% by weight. These polymer polyesterols are described by way of example in EP-A-250 351 and are usually prepared via free-radical polymerization of suitable olefinic monomers, such as styrene, acrylonitrile, acrylates, and/or acrylamide, in a polyesterol serving as graft base. The side chains are generally produced via transfer of the free radicals derived from growing polymer chains onto polyesterols. The polymer polyol comprises, alongside the graft copolymer, mainly the homopolymers of the olefins, dispersed in unaltered polyesterol.

In one preferred embodiment, the monomers used comprise acrylonitrile, styrene, and in particular exclusively styrene. The monomers are, if appropriate, polymerized in the presence of other monomers, of a macromer, of a moderator, and with use of a free-radical initiator, mostly azo compounds or peroxide compounds, in a polyesterol as continuous phase.

Macromers, also termed stabilizers, are linear or branched polyols with number-average molar masses of up to 2000 g/mol, comprising at least one terminal reactive olefinic unsaturated group. The ethylenically unsaturated group may be introduced by way of reaction with anhydrides (maleic anhydride, fumaric acid), with acrylate derivatives and with methacrylate derivatives, or else with isocyanate derivatives, such as 3-isopropenyl-1,1-dimethylbenzyl isocyanate, isocyanatoethyl methacrylate, onto an existing polyol.

During the free-radical polymerization process, the macromers are concomitantly incorporated into the copolymer chain. The result is formation of block copolymers having a polyester block and pplyacrylonitrile-styrene block, and these act as compatibilizer at the boundary between continuous phase and disperse phase, and suppress agglomeration of the polymer polyesterol particles. The proportion of the macromers is usually from 1 to 15% by weight, based on the total weight of the monomers used for preparation of the polymer polyol.

It is significant for the invention that the proportion of polymer polyesterols (b-2) is more than 5% by weight, based on the total weight of component (b). In one preferred embodiment, the amount of constituents (b-1) present in component (b) is from 30 to 90% by weight, more preferably from 40 to 85% by weight, particularly preferably from 55 to 80% by weight, and the amount of (b-2) present in component (b) is from 10 to 70% by weight, more preferably from 15 to 60% by weight, particularly preferably from 20 to 45% by weight, based on the total weight of component (b).

Chain extenders are used, if appropriate, as component (c). Suitable chain extenders are known within the prior art. Preference is given to use of dihydric alcohols with molar masses below 400 g/mol, in particular in the range from 60 to 150 g/mol. Examples are ethylene glycol, 1,3-propanediol, diethylene glycol, 1,4-butanediol, glycerol, or trimethylolpropane, and also mixtures of these. It is preferable to use ethylene glycol.

The usual amount of the chain extender used is from 1 to 15% by weight, preferably from 3 to 12% by weight, particularly preferably from 4 to 8% by weight, based on the total weight of components (b) and (c).

The reaction of components (a) and (b) and, if appropriate, (c) usually takes place in the presence of blowing agents (d), comprising water (termed constituent (d-1)). Other blowing agents (d) which may be used alongside water (d-1) are well-known compounds with chemical or physical action (these being termed constituent (d-2)). Examples of physical blowing agents are inert (cyclo)aliphatic hydrocarbons having from 4 to 8 carbon atoms which evaporate under the conditions of polyurethane formation. Other blowing agents which may be used are fluorocarbons, such as Solkane® 365 mfc. In one preferred embodiment, only water is used as blowing agent.

It is further preferable that exclusively the abovementioned blowing agents (d-1) and/or (d-2) are used as blowing agents (d).

In particular, there is no use of nitrogen, air, or carbon dioxide as blowing agent for the purposes of this invention.

Accordingly, it is preferable that the invention provide no embodiments that use carbon dioxide, for example in dissolved form, as blowing agent.

In one preferred embodiment, the amount of water (d-1) used is from 0.5 to 3% by weight, preferably from 0.6 to 2% by weight, particularly preferably from 0.7 to 1.5% by weight, in particular from 0.75 to 1.3% by weight, based on the total weight of components (b) and, if appropriate, (c).

In another preferred embodiment, microbeads which comprise physical blowing agent are added as additional blowing agent (d-2), to the reaction of components (a), (b) and, if appropriate, (c). The microbeads may also be used in a mixture with the abovementioned additional blowing agents (d-2).

The microbeads (d-2) are usually composed of a shell composed of thermoplastic polymer with, in the core, a liquid, low-boiling gas based on alkanes. The preparation of these microbeads is described by way of example in U.S. Pat. No. 3,615,972. The microbeads generally have a diameter of from 5 to 50 μm. Examples of suitable microbeads are obtainable with Expancell® from Akzo Nobel.

The amount generally added of the microbeads is from 0.5 to 5%, based on the total weight of components (b) and, if appropriate, (c) and (d).

Catalysts (e) which may be used for production of the inventive polyurethane foams are the conventional polyurethane-formation catalysts, e.g. organotin compounds, such as stannous diacetate, stannous dioctoate, dibutyltin dilaurate, and/or tertiary amines such as triethylamine or preferably triethylenediamine, N-(3-aminopropyl)imidazole, or bis(N,N-dimethylaminoethyl) ether.

The preferred amount used of the catalysts is from 0.01 to 3% by weight, preferably from 0.05 to 2% by weight, based on the total weight of components (b) and, if appropriate, (c) and (d).

Crosslinking agents (f) may also be added to the reaction of components (a) and (b). It is preferable to use compounds having 3 or more groups reactive toward isocyanates and molar mass in the range from 60 to 250 g/mol. Examples are triethanolamine and/or glycerol. The usual amount used of the crosslinking agent is from 0.01 to 1% by weight, preferably from 0.1 to 0.8% by weight, based on the total weight of components (b) and, if appropriate, (c) and (d).

The reaction of components (a) and (b) takes place, if appropriate, in the presence of (g) auxiliaries and/or additives, e.g. cell regulators, release agents, pigments, surfactants, and/or stabilizers with respect to oxidative, thermal, hydrolytic, or microbial degradation.

The invention further provides a process for production of polyurethane foams with density of from 120 g/L to less than 300 g/L, via reaction of

a) a polyisocyanate component with

b) a polyol component, comprising the following constituents:

b-1) polyesterols, and

b-2) polymer polyesterols, where the proportion of polymer polyesterols (b-2) is from more than 5 to less than 50% by weight based on the total weight of component (b), and

c) if appropriate, chain extenders, in the presence of

d) blowing agent comprising water.

The preferred embodiments described above for the inventive integral polyurethane foam likewise relate to the inventive process.

For production of polyurethane foams, components (a) and (b) are generally reacted in amounts such that the ratio of equivalents of NCO groups to the entirety of reactive hydrogen atoms is from 1:0.8 to 1:1.25, preferably from 1:0.9 to 1:1.15. A ratio of 1:1 here corresponds to an NCO index of 100.

The inventive integral polyurethane foams are used for steering wheels and preferably for shoe soles, in particular for intermediate shoe soles.

The invention therefore provides, alongside the inventive polyurethane foams, a shoe sole, in particular an intermediate shoe sole, with density of from 120 to less than 300 g/L, comprising the inventive polyurethane foams. The preferred embodiments explained above for the polyurethane foams likewise relate to the inventive shoe soles.

The inventive shoe soles have low density, and also good service properties and good processing properties, and can therefore in particular be used as shoe soles in sports shoes.

The inventive shoe soles can be produced separately or by way of direct injection. Both techniques are known in the prior art and are described by way of example in Kunststoffhandbuch [Plastics handbook] Volume 7, Polyurethane [Polyurethanes], 3^{rd} edition, 1993, Carl-Hanser-Veriag, page 387.

The invention therefore also provides sports shoes comprising the inventive shoe soles.

The inventive polyurethane foams are obtained via reaction of polyurethane system components, namely the isocyanate component (a) and the polyol component (b), which may, if appropriate, also comprise chain extenders (c).

The invention therefore also provides a polyurethane system for production of the inventive polyurethane foams, comprising

a) a polyisocyanate component and

b) a polyol component, comprising the following constituents:

b-1) polyesterols and

b-2) polymer polyesterols, where the proportion of polymer polyesterols (b-2) is from 5% by weight to less than 50% by weight, based on the total weight of component (b), and also, if appropriate,

c) chain extenders.

The above explanations of preferred embodiments apply to the polyurethane system.

The examples below are intended to illustrate the invention.

### EXAMPLES

Starting materials used:

Polyol 1: Polyesterol based on adipic acid and on a mixture of ethylene glycol and 1,4-butanediol in a molar ratio of 2:1, OH number=80 mg KOH/g, viscosity at 75° C.=300 mPas, measured to DIN 53015

Polyol 2: Polyesterol based on adipic acid and on a mixture of ethylene glycol and 1,4-butanediol in a molar ratio of 2:1, OH number=56 mg KOH/g, viscosity at 75° C.=650 mPas

Polyol 3: Hoopol PM245 from Hoocker; polymer polyesterol with 20% solids content, OH number=60 mg KOH/g

Polyol 4: Lupranol 4800 from Elastogran; polymer polyetherol with 45% solids content, OH number=20 mg KOH/g.

CE: Ethylene glycol

Cat 1: Amine catalyst

Crosslinking agent: triethylenediamine (85% in diethanolamine)

Stabilizer: cell stabilizer based on a silicone

Iso 187/2: isocyanate prepolymer from Elastogran based on 4,4′-MDI, on modified isocyanates, and on a polyesterol with functionality>2 and OH number 60 mg KOH/g; NCO content=23%

ESB 260: isocyanate prepolymer based on 4,4′-MDI, on modified isocyanates and on a mixture of polyesterols with average functionality>2 and average OH number 60 mg KOH/g; NCO content=23%

Production of integral foams:

The A and B components are vigorously mixed at 23° C. in the mixing ratios described in the examples, and the mixture is introduced into a sheet-shaped aluminum mold with dimensions 20×20×1 cm temperature-controlled to 50° C., the amount introduced being such as to give an integral foam sheet of density 250 g/L in the closed mold after foaming and curing.

TABLE 1
Overview of formulation for the examples

| | Exp. | | | |
|---|---|---|---|---|
| | 1 | 2 | C1 | C2 |
| A | | | | |
| Polyol 1 | 61.6 | 63.2 | 61.6 | — |
| Polyol 2 | — | — | — | 61.6 |
| Polyol 3 | 30.0 | 30.0 | — | 30.0 |
| Polyol 4 | — | — | 30.0 | — |
| CE | 6.0 | 5.5 | 6.0 | 6.0 |
| Amine catalyst | 1.1 | 1.6 | 1.1 | 1.1 |
| Water | 1.0 | 0.8 | 1.0 | 1.0 |
| Crosslinking | 0.2 | 0.5 | 0.2 | 0.2 |
| agent | | | | |
| Stabilizer | 0.1 | 0.1 | 0.1 | 0.1 |
| B | Iso 187/2 | ESB 260 | Iso 187/2 | Iso 187/2 |
| NCO content | 23 | 22 | 23 | 23 |

Results:
1 + 2: The inventive formulation gives fine-cell moldings without surface defects due, for example, to depressions. The moldings are dimensionally stable, i.e. exhibit no alterations in geometrical dimensions after demolding.
C1: The foams have coarse cell structure. The moldings have unsatisfactory surface.
C2: The test sheets have surface defects.

1. A polyurethane foam with density of from 120 g/L to less than 300 g/L,
obtainable via reaction of
a) a polyisocyanate component with
b) a polyol component, comprising the following constituents:
b-1) polyesterols with viscosity of from 150 mPas to 600 mPas, measured to DIN 53015 at 75° C., and
b-2) polymer polyesterols, where the proportion of polymer polyesterols (b-2) is from more than 5 to less than 50% by weight based on the total weight of component (b), and
c) if appropriate, chain extenders, in the presence of
d) blowing agent comprising water.

2. The polyurethane foam according to claim 1, wherein component (a) comprises polyisocyanate prepolymers obtainable via reaction of
(a-1) polyisocyanates with
(a-2) branched polyesterols.

3. The polyurethane foam according to claim 1, wherein component (b-1) has viscosity of from 200 mPas to 500 mPas, measured to DIN 53015 at 75° C.

4. A process according to claim 1, wherein water is the only blowing agent used.

5. The polyurethane foam according to claim 1, wherein the amount used of water (d) is from 0.6 to 3% by weight, based on the total weight of components (b) and (c).

6. The polyurethane foam according to claim 1, which is a flexible integral polyurethane foam.

7. A shoe sole comprising a polyurethane foam according to claim 1.

8. A process for production of polyurethane foams with density of from 120 g/L to less than 300 g/L, via reaction of
a) a polyisocyanate component with
b) a polyol component, comprising the following constituents:
b-1) polyesterols with viscosity of from 150 mPas to 600 mPas, measured to DIN 53015 at 75° C., and
b-2) polymer polyesterols, where the proportion of polymer polyesterols (b-2) is from more than 5 to less than 50% by weight based on the total weight of component (b), and
c) if appropriate, chain extenders, in the presence of
d) water as blowing agent.

9. The use of a polyurethane foam according to claim 1 for production of shoe soles.

10. A polyurethane system for production of a polyurethane foam according to claim 1, comprising
a) a polyisocyanate component and
b) a polyol component, comprising the following constituents:
b-1) polyesterols and
b-2) polymer polyesterols, where the proportion of polymer polyesterols (b-2) is more than 5% by weight, based on the total weight of component (b), and also, if appropriate,
c) chain extenders.
